(19) United States
(12) Patent Application Publication
(10) Pub. No.: US 2008/0066991 A1
(43) Pub. Date: Mar. 20, 2008

(54) On-vehicle control apparatus powered by on-vehicle battery

(75) Inventors: Motoaki Kataoka, Kariya-shi (JP); Mamoru Sawada, Yokkaichi-shi (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/900,897

(22) Filed: Sep. 13, 2007

(30) Foreign Application Priority Data
Sep. 15, 2006 (JP) 2006-250993

(51) Int. Cl. B62D 5/04; B62D 6/00; G06F 19/00

(52) U.S. Cl. 180/443; 701/36; 701/41

(57) ABSTRACT

A controller controls an on-vehicle device having an operating member operated by a driver to receive a driver's operating force and an assisting mechanism giving an assisting force to the operating member. This mechanism is powered by an on-vehicle battery. The controller detects forces applied to the device and calculates a control amount giving the assisting force to the device based on results detected by the force detector. The control amount is calculated every type of the applied forces whose frequency bands are at least partly different from each other. The controller drives the assisting mechanism based on the control amount and detects an operating state of the battery. The controller adjusts the control amount such that, as the calculated battery state decreases in a powering function of the battery, the control amount for, of the applied forces, a specified force having specified frequency components is monotonously reduced.

### CROSS REFERENCES TO RELATED APPLICATION

The present application relates to and incorporates by reference Japanese Patent Application No. 2006-250993 filed on Sep. 15, 2006.

### BACKGROUND OF THE INVENTION

1. Field of the Invention

The present invention relates to an on-vehicle control apparatus for controlling electronic various devices in a selective manner that allows its control states to be selected in accordance with the relationship between electric power consumption of the vehicle and how degree the control influences vehicular running stability.

2. Description of the Related Art

In a vehicle, various kinds of electronic devices are mounted which need to be controlled depending on how the vehicle runs. Such electronic devices include a power steering apparatus and a braking device. The power steering apparatus needs a steering controller. In the case of the braking device, a braking-assist control apparatus is required for the vacuum booster of a brake and a regenerative braking apparatus in hybrid vehicles.

The power steering apparatus includes a steering motor to provide a driver's wheel (i.e., handle operated by a driver) with a steering-assist force in reply to a driver's steering force given to the driver's wheel. The steering motor is driven and controlled by a steering controller. In the steering controller disclosed by Japanese Patent Laid-open Publication No. 2005-047426, the steering force applied to the driver's wheel is assisted depending on forces applied by driver's operations, so that vibration coming from tires is prevented from transferring to the driver's wheel.

Specifically, in this steering controller, a driver's steering force given to the driver's wheel and a force (i.e., disturbance) due to vibration coming from tires are detected. The detected force is used to control by giving two types of drive currents to the steering motor. One type is for assisting the steering force and the other type is for removing, from the motor output force, vibration of frequency components indicating the vibration coming from the tires. By supplying those two types of drive currents to the steering motor, an assist to the driver's steering force is obtained and the vibration caused at the tires is removed from the driver's wheel.

In recent years, vehicles tend to equip a variety of types of electronic devices, such as air conditioner, control braking system, and car audio, which consume power (i.e., power from the battery and power by the generator). Hence it is generally required to manage how to obtain the power and how to use the obtained power. This power management is especially significant for hybrid electric vehicles and fuel-cell electric vehicles.

However, the foregoing steering controller operates without taking it consideration whether or not the on-vehicle battery is in a reduced state of its power supply capacity. Therefore, the foregoing steering controller will cause a problem that, when the power supply capability (or capacity) of the on-vehicle battery is reduced, continuously assisting the steering force which consumes a relatively larger amount of electronic power results in accelerating a situation that the battery is brought into its power-supply stop.

When the battery is brought into its complete power-supply stop, the assisting force to the driver's wheel suddenly disappears, giving dreadfully an unpleasant feeling to the driver. In addition, in such a condition where there is no assist force, it is difficult to remove vibration caused at tires or vibration of a steering system due to disturbances on the road and/or driver's steering operations. The vibration which has caused in such ways will lower the operability of the driver's wheel, making it difficult to control well the running behaviors of the vehicle.

In this way, some on-vehicle controllers have a basic operation function responding to driver's operations and an assisting control function assisting the basic operation function. However, in cases where the on-battery and/or other storage means cannot provide available power any more, the on-vehicle controllers are immediately returned to have only its basic control functions, making the crew feel unpleasantly and influencing more or less the stable running capability of the vehicle.

### SUMMARY OF THE INVENTION

The present invention has been made due to the above difficulties, and has an object of selectively controlling the operated states of on-vehicle controllers such as a steering controller, depending on the states of power supplied from the battery to the controllers, while still securing necessary control functions for the vehicle.

In order to achieve the above object, the present invention provides as one aspect thereof a controller for controlling a device mounted in a vehicle, the device having an operating member operated by a driver to receive a driver's operating force and an assisting mechanism giving an assisting force to the operating member, the assisting mechanism being powered by a battery mounted in the vehicle, the controller comprising; a force detector that detects forces applied to the device, the applied forces including the driver's operating force; a calculator that calculates a control amount giving the assisting force to the device, based on results detected by the force detector, the control amount being calculated every type of the applied forces whose frequency bands are at least partly different from each other; a driver that drives the assisting mechanism based on the control amount calculated by the calculator; a battery state detector that detects an operating state of the battery; and an adjustor that adjusts the control amount such that, as the calculated battery state decreases in a powering function of the battery, the control amount for, of the applied forces, a specified force having specified frequency components is monotonously reduced.

Preferably, the device is a steering apparatus mounted in the vehicle and powered by the battery, the operating member is a driver's wheel (i.e., handle operated by a driver on the vehicle) of the steering apparatus, the assisting mechanism is a power steering mechanism, and the specified force is a driver's steering force serving as the driver's operating force, wherein the power steering mechanism includes an electric motor driven by the driver and powered by the battery.

Still preferably, the specified force is a driver's steering force serving as the driver's operating force and the specified frequency components are frequencies of the driver's steering force, of which banes are at least partly lower than other forces of the forces detected by the detector.

In the steering controller, it is general that control for forces having lower frequencies needs larger amounts of power. Based on this, the present invention adopts the way of reducing the steering control amounts for such forces having the lower frequencies, when the on-vehicle battery decreases its powering function. Control to suppress forces of relatively higher frequencies is still continued, because such control does not need larger amounts of power.

Therefore, when an on-battery is lowered in its powering performance, the power consumption of the battery is lessened so as to prevent the vehicle's basic performances from being influenced and it is possible to still continue control for suppressing forces (usually disturbance or noise) of higher frequencies transmitted to the driver's wheel. The driver's operability of the driver's wheel can be prevented from being influenced, while the battery is prevented from losing its powering function.

In the present invention, the force detected by the detector or detecting means includes driver's steering forces and forces originating as vibration (disturbance or noise) from the steering mechanism and the tires.

In the present invention, “monotonously reduced” includes a step-wise reduction or a continuous reduction of the control amount (i.e. an amount to be controlled) for adjusting the steering force. That is, “monotonously reduced” means no increase in the control amount.

Still in the present invention, the “battery state” is represented by various factors, such as battery voltage (terminal voltage) based on charged voltage, battery degraded state, and remaining power supply capability (i.e., amount of current to be expected).

### BRIEF DESCRIPTION OF THE DRAWINGS

In the accompanying drawings:

FIG. 1 is a block diagram showing an outlined configuration of a steering controller according to an embodiment of the present invention;

FIG. 2 shows resonant frequency characteristics of vibrations inputted as disturbances to a driver's wheel and a driver's steering force given to the driver's wheel;

FIG. 3A is a flowchart showing a series of processes for calculating a control amount adopted in the embodiment;

FIG. 3B is a flowchart showing a series of processes for limiting the operations of a power steering ECU employed in the embodiment;

FIG. 4 is a graph showing a map for setting a gain indicative of the relationship between battery voltages and gains to be set;

FIG. 5A shows graphs showing changes in power consumption on various types of forces including vibration;

FIG. 5B is a table explaining differences among power consumption obtained when the assisting amount changes;

FIG. 6 is a flowchart showing a series of processes for calculating control amounts in a modification of the embodiment; and

FIG. 7 is a block diagram showing an outlined configuration of a steering controller according to another modification of the present invention.

### DETAILED DESCRIPTION OF THE PREFERRED EMBODIMENTS

Hereinafter, an embodiment and modifications of the present invention will now be described with reference to the accompanying drawings.

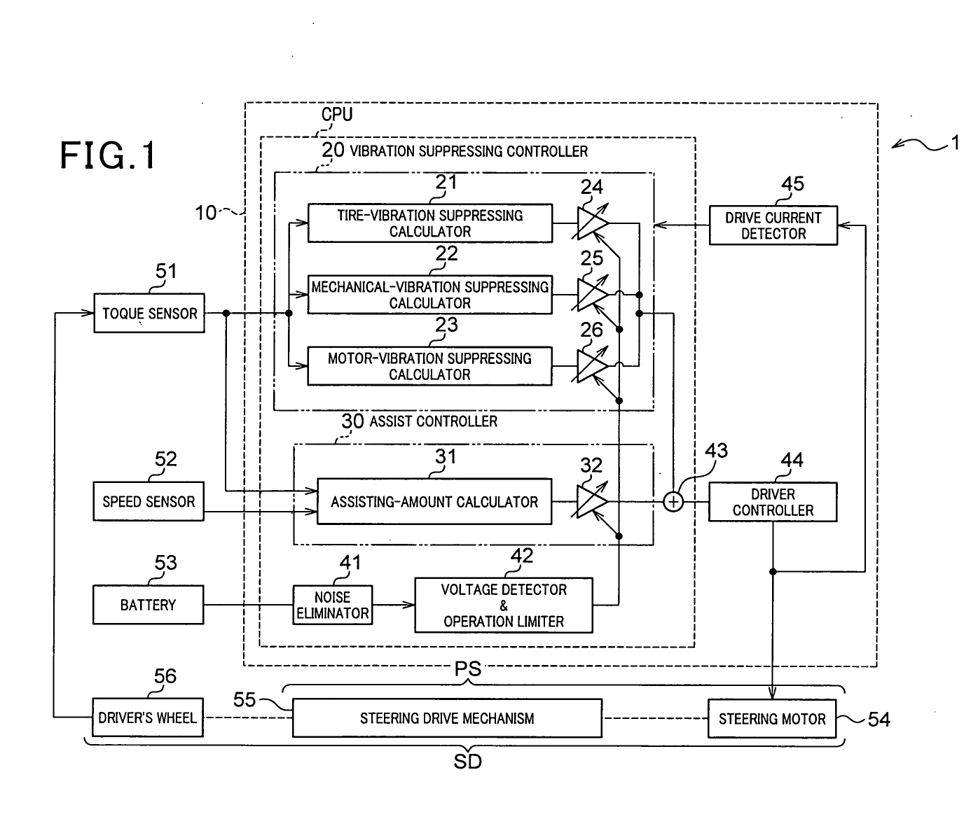

Referring to FIGS. 1-5A and 5B, a first embodiment will now be described. FIG. 1 shows in blocks the outlined configuration of a steering controller 1 to which the present invention is applied.

In addition to the steering controller 1, the vehicle according to the present embodiment is equipped with a torque sensor 51, a speed sensor 52, a battery 53, a steering motor 54, a steering drive mechanism 55, and a driver's wheel (i.e., handle) 56 operated by a driver on the vehicle.

The steering controller 1 is for example mounted in vehicles such as passenger cars and is formed to detect a force (i.e., a driver's steering force or a force as a disturbance or noise) externally applied to the driver's wheel 56 to drive the steering motor 54 in such a manner that the external force is amplified or attenuated selectively. For instance, when a driver's steering force is applied to the driver's wheel 56, the steering controller 1 drives the steering motor 54 so as to assist this steering force. In contrast, the driver's wheel 56 is given vibration (disturbance), the steering controller 1 drives the steering motor 54 so as to suppress this vibration transmitted and coming along a steering apparatus SD comprising the steering motor 54, steering drive mechanism 55, and driver's wheel 56. Of these, the steering drive mechanism 55 and the steering motor 54 compose a power steering mechanism PS.

Practically, as shown in FIG. 1, the steering controller 1 is provided with a power steering ECU (electronic control unit) 10, the torque sensor 51, the peed sensor 52, and the battery 53.

The torque sensor 51 has a known torque sensing structure to not only detect a bending moment and a shearing force, which are external forces applied to the driver's wheel 56, but also output an electric signal indicating the detected torque. The electric signal is sent to the power steering ECU 10. As long as it is assured that the torque sensor 51 detects such externally applied forces, the torque sensor 51 may be loaded to either the driver's wheel 56 or the steering drive mechanism 55 driven responsively to driver's steering operations given to the driver's wheel 56.

The speed sensor 52 has a known structure to detect the running speed of a vehicle on which the steering controller 1 is mounted, and outputs to the power steering ECU 10 an electric signal indicating the detected running speed.

The battery 53 is mounted on the vehicle to power various electronic devices including the power steering ECU 10 and the steering motor 54. The steering motor 54, which is powered by the battery 53, is controlled in its drive by the power steering ECU 10, so that a drive force for steering is given to the steering drive mechanism 55 in a controlled manner.

The steering drive mechanism 55 is structured to transmit, to not-shown wheels (steered wheels) of the vehicle, both a steering force given in response to driver's operations at the driver's wheel 56 and a drive force given in response to the drive of the steering motor 54. In order to operate in such a way, this steering drive mechanism 55 has, by way of example, a known rack and pinion mechanism.

The power steering ECU 10 is formed as a known computer configuration provided with a CPU (central processing unit), ROM (read-only memory), RAM (random access memory), and others (which are not shown), in which the CPU performs a variety of given programs to function as a vibration suppressing controller 20, an assist controller 30, a voltage detector & operation limiter 42, an adder 43, a drive controller 44, and a drive current detector 45.

The configuration of the power steering ECU 10 is not always limited to the above, that is, the functional configuration on the processing executed by the CPU. Alternatively, the power steering ECU 10 may be formed in part or as a whole by hardware including analog and/or digital logic circuits other than the software processing configuration.

As a general description, the vibration suppressing controller 20 accepts the electric signal outputted by the torque sensor 51 as well as an electric signal outputted by the drive current detector 45 and on the basis of those accepted signals, calculates an amount to be controlled of a force (control amount) for the steering motor 54. The calculated control amount is for suppressing the vibration coming to the driver's wheel 56.

Practically, the vibration suppressing controller 20 is also provided with a tire-vibration suppressing calculator 21, a mechanical-vibration suppressing calculator 22, and a motor-vibration suppressing calculator 23. The calculators 21-23 are related to gain adjustors 24-26, respectively, consisting of the tire-vibration gain adjustor 24, mechanical-vibration gain adjustor 25, and motor-vibration gain adjustor 26.

The tire-vibration suppressing calculator 21 is formed to calculate a control amount of a force for suppressing vibration of 20-60 Hz, which corresponds to frequency components of the vibration caused at a tire(s) and transmitted to the driver's wheel 56.

Further, the mechanical-vibration suppressing calculator 22 is formed to calculate a control amount of a force for suppressing vibration of 1-30 Hz, which corresponds to frequency components of the vibration caused at a vehicle body and the steering drive mechanism 55 and transmitted to the starring wheel 56.

The motor-vibration suppressing calculator 23 is formed to calculate a control amount of a force for suppressing vibration of DC (direct current; 0 Hz)-approximately 100 Hz, which corresponds to frequency components of the vibration caused at the steering motor 45 and transmitted to the driver's wheel 56.

Each of the gain adjusters 24-26 is formed to multiply the control amount calculated by each of the vibration suppressing calculators 21-23 by a specified variable gain (i.e., a coefficient within a range of 0-1), so that the control amount is outputted as an electric signal without any changes or reduced on the multiplied gain. The gains of the respective gain adjustors 24-26 are controllably set by the voltage detector & operation limiter 42, adjustor by adjustor, respectively.

The assist controller 30 is functionally provided with an assisting-amount calculator 31 and an assisting-amount gain adjustor 32.

The assist-amount calculator 31 receives the output signals of the torque sensor 51 and the speed sensor 52 and uses the received signals to calculate a control amount of an assist force given to the steering motor 54. When being given to the steering motor 54, this control amount is to amplify (that is, assist) a driver's steering force given to the driver's wheel 56. More specifically, this control amount is for amplifying a force having frequency components of less than 10 Hz including a DC component (in the present embodiment, this frequency band is called “specified frequencies” or “specified frequency components”), which are frequency components of the driver's steering force given to the driver's wheel 56 from a driver.

By the way, in the present embodiment, the four types of forces are exemplified as above. These forces result from not only vibrations caused at the power steering mechanism PS and the tires but also forces responding to driver's steering operations. That is, the vibrations may be transmitted as externally inputted forces (disturbances or noise) to the driver's wheel 56 if there is no damping against the disturbances. The driver's steering operations are given as an externally inputted force to the driver's wheel 56 when there is a driver's handling action.

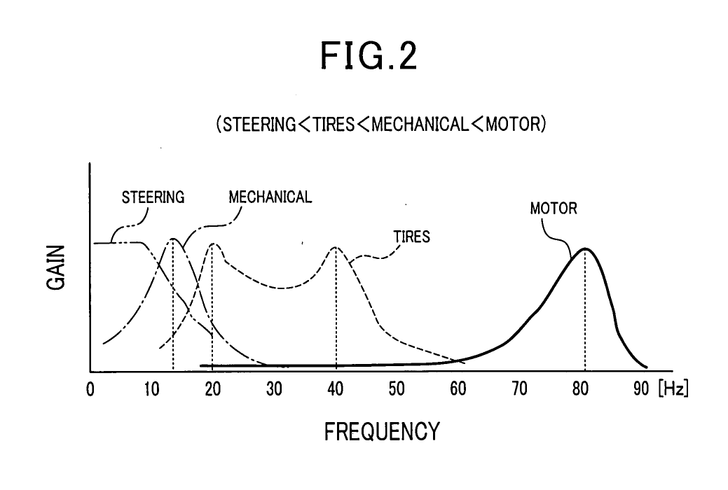

Thus, the four types of forces have the frequency bands of 20-60 Hz (tires), 1-30 Hz (mechanical), 0-approximately 100 Hz (motor), and 0-10 Hz (steering) as stated above, which have resonant characteristics expressed as a frequency and gain characteristics shown in FIG. 2. As shown in FIG. 2, each curve of the resonant characteristics of the four forces (vibrations as disturbances and driver's steering forces) have own peak or high gain range. The resonant characteristics of the motor has a peak at approximately 80 Hz, the resonant characteristics of the tires have two peaks at approximately 20 and 40 Hz, the resonant characteristics of the mechanical components have a peak at approximately 12 Hz, and the resonant characteristics of the steering force has a high gain range in a range of lower than 12 Hz. Therefore, in view of the peak positions, it can be decided such that the vibration from the motor, the vibration from the mechanical components, the vibration from the tires, and the steering force become lower in the frequencies in this order. Thus, the force providing the lowest frequency characteristics is the steering force.

Like the foregoing gain adjustors 24-26 in the vibration-suppressing controller 20, the assisting-amount gain adjustor 32 is formed to multiply, by a specified controllable gain, the control amount calculated by the assisting-amount calculator 31. As a result, depending on how much the gain is given, the control amount is outputted as an electric signal without any reduction or with a reduction. This gain of the adjustor 32 is controllably set by the voltage detector & operation limiter 42.

The amounts of control calculated in both the vibration suppressing controller 20 and the assist controller 30 are added to each other, and then sent to the drive controller 44 as an electric signal.

The drive controller 44 receives the electric signal indicative of an added control amount from the adder 43, and gives it to the steering motor 54 to control the steering motor 54.

The drive current detector 45 is placed to sample a command signal, i.e., a drive current supplied to the steering motor 54, at intervals, i.e., at a given sampling frequency. The detected drive current is given to the vibration suppressing controller 20 as a corresponding signal.

Meanwhile the voltage detector & operation limiter 42 is electrically connected with the battery 53 via a noise eliminator 41 including for example a CR (capacitor and resistor) circuit having a given time constant and is formed to detect the terminal voltage of the battery 53 (simply, a battery voltage). By placing the noise eliminator 41 before the voltage detector & operation limiter 42, it is prevented that the voltage detector & operation limiter 42 receives erroneous instantaneous values of the battery voltage. Such erroneous instantaneous voltage values are due to, for instance, noise in the detected voltage of the battery 53.

Depending on the detected voltage of the battery 53, the voltage detector & operation limiter 42 adjusts the gain at each of the gain adjustors 24-26 and 32 such that, thanks to the adjusted gains, the power consumption of the drive controller 44 is controlled, or suppressed to avoid the battery 53 from stopping its powering function. If the battery 53 stops its powering function, the steering controller 1 will not be driven any more. Hence such a stop of the battery 53 is prevented by adjusting the gains.

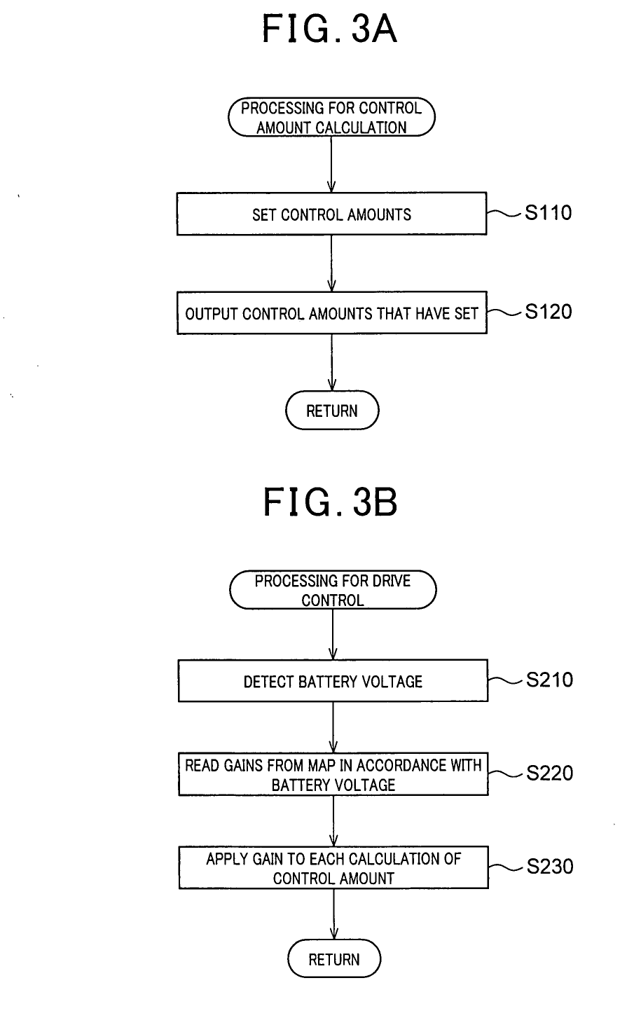

The processing executed by the CPU of the power steering ECU 10 functionally provides the vibration suppressing controller 20 and the assist controller 30, which functionally include the calculators 21-23 and 31, respectively. Each of the calculators 21-23 and 31 (i.e., the CPU) performs a series of processes for calculating the control amount of a force, as shown by the flowchart in FIG. 3A.

When the series of processes shown in FIG. 3A is started, each of the calculators 21-23 and 31 reads in the detected electric signals from the sensors 51 and 52 and/or the detector 45 to decide control amounts for the steering motor 54 (step S110).

Concretely, each of the calculators 21-23 in the vibration suppressing controller 20 has a filter and a map to calculate a control amount for suppressing vibration of frequency components specified for each calculator. Meanwhile the calculator 31 in the assist controller 30 has another filter and a map, for example, a non-linear map to calculate an amount to be controlled for assisting a driver's steering force. The filters in the calculators 21-23 and 31 are given pass bands of frequencies, respectively, which are for example 20-60 Hz (tires), 1-30 Hz (mechanical), 0-approximately 100 Hz (motor), and 0-10 Hz (steering), as stated. The filers serve as frequency analyzers.

After setting the control amounts, data indicative of such amounts are outputted (step S120), before the processing is ended.

Referring to FIG. 3B, the operation-limiting processing of the voltage detector & operation limiter 42 (i.e., the operations executed by the CPU of the power steering ECU 10 in the present embodiment) will now be described.

First of all, the voltage detector & operation limiter 42 detects a terminal voltage of the battery 53 (battery voltage) via the noise eliminator 41 (step S210). Then the voltage detector & operation limiter 42 applies the battery voltage to an internally stored gain setting map to read out gains therefrom for the respective calculators 21-23 and 31 depending on the values of the battery voltage (step S220).

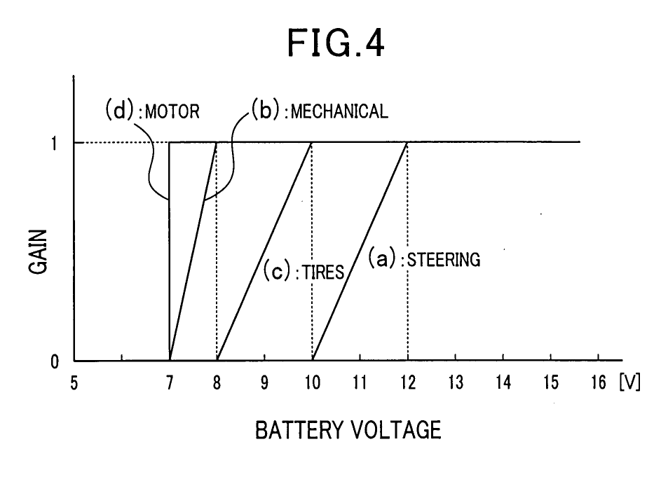

One example of the gain setting map is shown in FIG. 4, in which the gain for each of the control amounts for suppressing the motor vibration, mechanical vibration, tire vibration, and power steering assist for the respective calculators 21-23 and 31 is uniquely decided by specifying a value of the battery voltage. Incidentally, in FIG. 4, a battery voltage of 5 V is set as a minimum operable voltage for the CPU.

Specifically, the gain applied to the control amount for assisting the steering force, which is targeted for frequency components of less than 10 Hz, is set as shown by a line (a) in FIG. 4, where the gain is kept “1” in a range of battery voltages higher than 12 V and continuously deceases from “1” to “0” as the battery voltage decreases from 12 V to 10V. In addition, this gain is forcibly set to 0 in a range of battery voltages less than 10 V.

The gain applied to the control amount for suppressing the mechanical vibration, which is targeted for frequency components of 1 to 30 Hz, is set as shown by a line (b) in FIG. 4, where the gain is kept “1” in a range of battery voltages higher than 8 V and continuously decreases from “1” to “0” as the battery voltage decreases from 8 V to 7V. In addition, this gain is forcibly set to 0 in a range of battery voltages less than 7 V.

The gain applied to the control amount for suppressing the tire vibration, which is targeted for frequency components of 20 to 60 Hz, is set as shown by a line (c) in FIG. 4, where the gain is kept “1” in a range of battery voltages higher than 10 V and continuously decreases from “1” to “0” as the battery voltage decreases from 10 V to 8 V. In addition, this gain is forcibly set to 0 in a range of battery voltages less than 8 V.

The gain applied to the control amount for suppressing the motor vibration, which is targeted for frequency components of 0 (i.e., DC component) to approx. 100 Hz, is set as shown by a line (d) in FIG. 4, where the gain is kept “1” in a range of battery voltages higher than 7 V and sharply decreases down to 0 when the voltage decreases less than 7 V.

By the way, the lines (a)-(c) in FIG. 4 each show a continuous decrease, but this is just an example. An alternative is that each line decrease with one or more steps, which still fall into the monotonous decrease.

As understood from FIG. 4, when the terminal voltage of the battery 53, which represents one of the power-supply capabilities thereof, begins to reduce, forces whose frequencies are relatively lower are set to be small as early as possible.

Practically, when it is assumed that the terminal voltage of the battery 53 is about 11.4 V, the gain at the assisting-amount gain adjustor 32 is set to 0.75, while the gains at the other gain adjusters 24-26 are still set to 1. As a result, the control amount from the assisting-amount calculator 31 is reduced by 0.75 times to be given to the adder 43 and the amounts of control from the other calculators 21-23 are given to the adder 43 without any reduction.

When it is, assumed that the terminal voltage of the battery 53 is about 9.15 V, the gain at the assisting-amount gain adjustor 32 is already set to 0 and the gain at the tire-vibration gain adjustor 24 is set to 0.5, while the gains at the remaining gain adjustors 25 and 26 are still kept at 1. As a result, the control amount from the assisting-amount calculator 31 is reduced down to 0 to be given to the adder 43 and the control amount from the tire-vibration suppressing calculator 21 is also reduced by its half. Meanwhile the control amounts of control from both the mechanical-vibration suppressing calculator 22 and the motor-vibration suppressing calculator 23, which are targeted for forces having relatively higher frequency components (and their frequency bands are wider), are given to the adder 43 without any reduction.

As shown in FIG. 4, as the battery voltage decreases, the decrease of each gain for the forces due to the vibrations other than the steering force shown by (a) starts immediately after completion of decreasing control of the previous gain (refer to (c), (b) and (d) in FIG. 4).

Incidentally, the graphs shown in FIG. 4, that is, the gain setting map, can be changed into other modes. For example, the order of the gain curves (c)-(d) may be changed in FIG. 4 according to designing the apparatus. That is, the design may be done such that, as the battery voltage decreases, the gain curve (b) for suppressing the mechanical vibration may be reduced prior to the gain curve (c) for suppressing the tire vibration

(Experiments)

Experiments for confirming the gain setting according to the present embodiment were conducted. That is, the experiments were done to confirm the early and positive suppression of forces having lower frequency components.

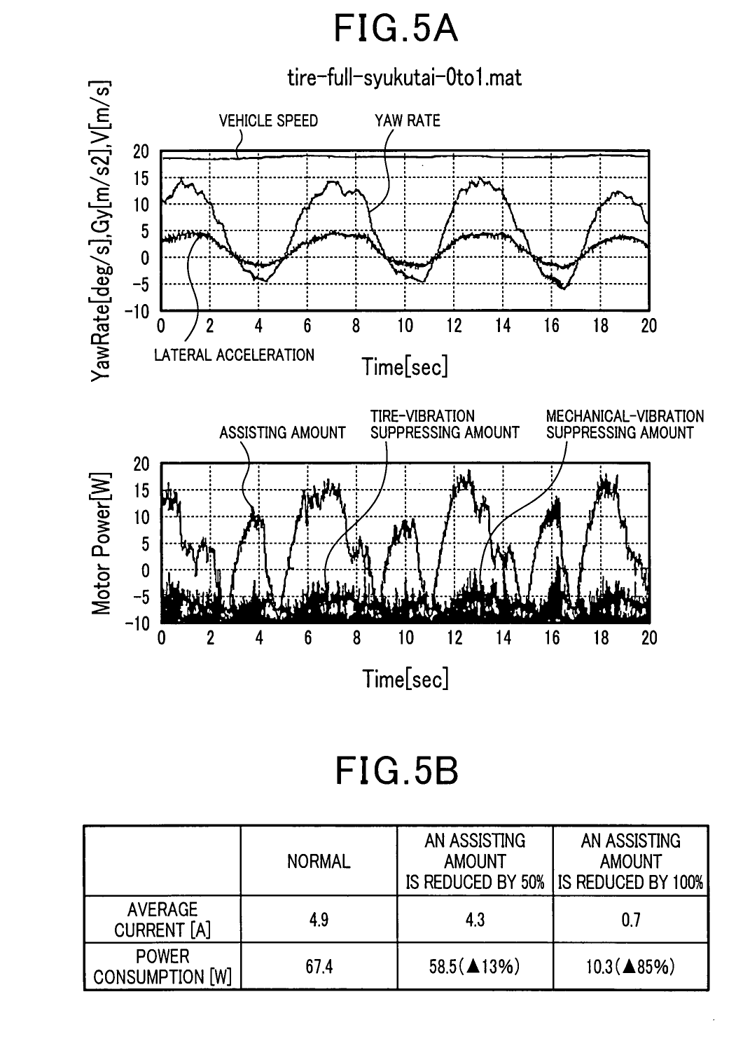

The experiment results are shown in FIGS. 5A and 5B. FIG. 5A includes the two graphs consisting of a first graph indicating temporal changes in vehicle speed, the amplitude of yaw rate, and the amplitude of lateral acceleration (upper one) over time and a second graph indicating temporal changes in amounts of power consumption based on the amounts of control for each frequency band. On the other hand, FIG. 5B explains a relationship between a reduction in the control amount for the power steering and the power consumption.

The results shown in FIG. 5A were obtained by measuring and graphing data of the power consumed by the steering controller 1 in a condition where the vehicle speed is constant and approx. 65 km/h (18 m/s) at which time the driver's wheel is turned left and right at intervals of approx. 6 seconds. Additionally, in acquiring the data shown in FIG. 5A, the gains set by all the gain adjustors 24-26 and 32 are set to “1.” In particular, in the lower graphs shown in FIG. 5A, the amounts of control were depicted as graphs for each of frequency bands. That is, there are mutual-separately depicted i) a power consumption based on an assisting control amount (depicted as an assisting amount) calculated by the assisting-amount calculator 31, ii) a power consumption based on a mechanical-vibration suppressing control amount (depicted as a mechanical-vibration suppressing amount) calculated by the mechanical-vibration suppressing calculator 22, and iii) a power consumption based on a tire-vibration suppressing control amount (depicted as a tire-vibration suppressing amount) calculated by the tire-vibration suppressing calculator 21. Since the experiments showed that a power consumption based on a motor-vibration suppressing control amount calculated by the motor-vibration suppressing calculator 23 was almost the same as the tire-vibration suppressing amount, the depiction thereof is omitted in FIG. 5A.

The graphs (refer to the lower graphs in FIG. 5A) clearly shows that the amounts of power consumption become larger in the order of the assisting amount, mechanical-vibration suppressing amount, tire-vibration suppressing amount, and motor-vibration suppressing amount (this graph is not shown in FIG. 5A, though) every time the driver's wheel 56 is turned right or left. An average over the total amount of power consumption is 67.4 W and a ratio among the assisting amount, mechanical-vibration suppressing amount, and tire-vibration suppressing amount was roughly 15:3:1.

In the present embodiment based on the present invention, study of the present inventors revealed that the lower the frequency components of vibration to which amounts of control are applied, the larger the power consumption required. Thus the inventors conceived a concept that, when the battery 53 is in its powering-function reduced state, suppressing (or reducing) amounts of control suppressing, at least, vibration of lower frequency components will lead to saving the power consumption of the battery 53, while still maintaining many of the functions of the objective devices operating on the power from the battery 53.

Based on the above concept, measurement about the power consumption (average power) was performed for mutually comparing states where the normal operation was done with no adjustment of the gains, the assisting amount (consuming the largest power) was reduced by 50%, and the assisting amount is reduced by 100%. The results are provided in FIG. 5B.

As shown in FIG. 5B, when the assisting amount is not reduced (i.e., the normal operation state), the amount of power consumption was 67.4 W, while the assisting amount is reduced by 50% from the normal operation state, the amount of power consumption was 58.8 W. Thus, this revealed that when compared with the case with no reduction in the assisting amount, the power consumption reduced by some 13%. Furthermore, a reduction of 100% in the assisting amount resulted in an amount of power consumption of 10.3 W. This showed that, when compared with the case with no reduction in the assisting amount, the power consumption reduced as much as some 85%.

Hence it was revealed that reducing the assisting amount to be applied to the vibration whose frequency components are the lowest (or whose frequency bands are the lowest) made it difficult that the battery 53 lost its powering function, with the amounts of control for the remaining functions on the battery 53 still maintained.

As detailed above, the steering controller 1 according to the present embodiment is provided with the power steering ECU 10, the processing of which CPU can be summarized as follows.

Based on the detected results of the torque sensor 51 and the drive current detector 45, the plural calculators 21-23 and 31 calculate respectively the amounts of steering control which are targeted to plural types of vibration of which frequency components (i.e. frequency bands) are different from each other. And those calculated results are used by the drive controller 44 to drive in a controlled manner the steering motor 54 which provides the driver's wheel 56 with a steering assist force. During such operations, the voltage detector &operation limiter 42 detects the battery state, i.e., the terminal voltage of the battery 53. As the detected battery state shows that weakness of the powering function advances deeply in the battery 53, the amounts of steering control which are targeted to external forces of which frequency components (frequency bands) are relatively lower are made to reduce monotonously (i.e., in a linear one step), thanks to the gain adjustors 24-26 and 32.

Accordingly, in s state where the battery 53 reduces its powering function, the steering assist control for external forces whose frequency components (i.e. frequency bands) are relatively higher can be continued. It is therefore possible to prevent or suppress, of all the external forces, the external forces having relatively higher frequency components from affecting badly the driver's operability of the driver's wheel 56. With the operability of the driver's wheel 56 maintained, the battery 53 can be prevented from losing its powering function.

Further, in the steering controller 1, using the detected results of the torque sensor 51 and the speed sensor 52, the assisting-amount calculator 31 calculate a steering control amount that amplifies an external force (i.e., a driver's steering force) of specific frequency components (i.e., approx. less than 10 Hz). In addition to the foregoing reduction adjustment, in the steering controller 1, using the detected results of the toque sensor 51 and the drive current detector 45, the calculators 21-23 calculates steering amounts of control that damping (suppressing) external forces of which frequency components are higher than the specific frequency components of the driver's steering force.

As a result of the above calculation, the steering controller 1 is able to amplify the force components having the relatively-lower specific frequencies, that is, the driver's steering force components. Thus the driver's steering operations are assisted suitably, giving a pleasant steering feeling to the driver.

In the present steering controller 1, it can also be said that the external forces having frequency components part of which is higher than the specific frequencies are damped (suppressed). It is thus possible to prevent or suppress vibration components on such external forces from being transmitted to the driver's wheel 56.

Particularly, when the battery 53 is brought into its degraded-function state, the assisting-amount calculator 31 reduces the steering control amount, while the other calculators 21-23 maintain their steering control amounts. Hence, even in such a degraded-function state of the battery 53, it is possible to suppress vibration fed to the driver's wheel 56.

Further, when the calculators 21-23 and 31 receive the detected results from the torque sensor 51 and the drive current detector 45, and the torque sensor 51 and the speed sensor 52, respectively. The calculators 21-23 and 31 use the filtered signals to make reference to their maps in order to obtain control amounts for steering.

Thus, the steering control amounts can be decided easily depending on the detected results of the torque sensor 51 and the drive current detector 45, thereby simplifying the configuration or calculation for obtaining the steering control amounts compared with a higher analysis of those detected results with the use of a complex calculation technique.

In such an operation the steering control amount, the voltage detector & operation limiter 42 detects the battery state, i.e., the terminal voltage of the battery 53. When the detected battery state shows a decrease in the powering capability of the battery 53, the voltage detector & operation limiter 42 also operates as a limiter for the power saving. That is, as such a decrease advances, the gain adjusters 24-26 and 32 are decreased in the order of ascending sequence (i.e., from lower frequency components to higher frequency components). Thus, in this order, the control amounts from the calculators 21-23 and 31 are decreased as well.

Accordingly, during decreasing the powering capability of the battery 53, the control amounts for forces having lower frequency components are lowered in turn in the foregoing ascending order, that is, in the descending order on which the force or vibration to be controlled consumes more power in the battery 53. The heavier the decrease in the powering capability, the smaller the consumed power of the battery 53. Hence the battery 53 can steadily be prevented from stopping its powering function.

Furthermore, the voltage detector & operation limiter 42 enables the gain adjustors 24-26 and 32 to multiply the outputs from the calculators 21-23 and 31 by the coefficients (gains) of 0 to 1, whereby the outputs from the calculators 21-23 and 31 are reduced respectively. Hence, the steering controller 1 is still simplified in its structure in realizing the voltage detector & operation limiter 42 and gain adjustors 24-26 and 32.

The voltage detector & operation limiter 42 is formed to detect the terminal voltage of the battery 53, which indicates the battery state. Compared with other means, the battery state can be detected simply and easily.

In addition, the steering controller 1 is provided with the noise eliminator 41 connected to the battery 53 to eliminate AC components from the output of the battery 53. The steering controller 1 can be controlled in its steering operations, independently of instantaneous values of the battery voltage. The noise eliminator 41 may be produced with the use of software processing on waves of the battery voltage.

(Modifications)

The foregoing embodiment cannot be limited to the above explained structure, but may be developed into various modified structures, as long as those modifications fall into the technical scope of the present invention.

For instance, how to reduce the steering control amount can be modified into another way. In the foregoing embodiment, the steering control amount is reduced continuously as the powering capability of the battery 53 reduces. But this is just one example. An alternative is that the steering control amount is reduced stepwise, such as one or more step manner, as the powering capability of the battery 53 (e.g., the battery voltage) reduces.

Another modification concerns with what kind of physical value is detected as a parameter indicating the “battery state.” In the foregoing embodiment, such a parameter was the voltage of the battery 53. Instated of the battery terminal voltage, the charging voltage, the degraded state, the power supplying amount (the current amount), or other factors of the battery 53 can be used as such a parameter, provided that such amounts are detected to show the powering state of the battery 53.

Another modification concerns with adjusting the control amount for reducing the power consumption of the battery 53. In this respect, the foregoing embodiment adopts the way in which the control amounts calculated by the calculators 21-23 and 31 (especially the calculator 31) are multiplied by gains. However this is not a sole solution. Not to exceed a previously set limit for each control amount, the control amounts may be controlled at their previously set limits by cutting them.

In this limiting way, the amount for assisting the steering may be reduced at a time instant that is unexpected for a driver. However, in consideration of such sudden changes in the assisting force, which will give an unpleasant operational feeling to the drive, the foregoing gain-multiplying way is better than the limiting way.

Another modification is concerned with calculation of the control amounts. In the foregoing embodiment, as shown in FIG. 3A, the map is made reference to decide control amounts in accordance with detects outputted from the toque sensor 51 and drive current detector 45 (or speed sensor 52). Instead of this, the detected results are subjected to extraction of respective frequency bands to the calculators 21-23 and 31, and then the control amounts are calculated to amplify or decay vibration (force) every frequency band.

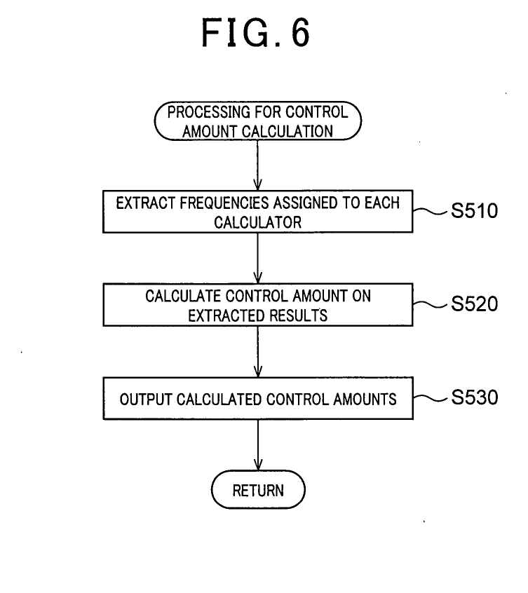

In this case, a flowchart shown in FIG. 6 is executed by a steering controller.

First, from the detected various signals, signals of frequency components, which are necessary in the steering controller, are extracted (step S510). For example, the assisting-amount calculator 31 amplifies a signal of frequencies of less than 10 Hz, so that the necessary frequency components for this are less than 10 Hz. For the mechanical-vibration suppressing calculator 22, necessary frequency components are 1-30 Hz.

Then control amounts on the extracted frequency components are calculated (step S520). Since the suppressing calculators 21-23 are for suppressing the vibration coming from outside the driver's wheel, the control amounts are for example are based on the waves obtained by reversing signal waves of the inputted frequency components. On the other hand, the assisting-amount calculator 31 detects a signal of less than 10 Hz, and calculates a control amount to make an assisting amount larger for a driver's steering force whose frequencies are less than 10 Hz.

The calculated control amounts are outputted to the adder 43 (step S530), before the control-amount calculation processing is terminated.

In this steering controller according this modification, when inputting the signals detected by “the torque sensor 51 and the drive current detector 45” or “the torque sensor 61 and the seed sensor 54”, the calculators 21-23 and 31 analyze the frequency components of the inputted signals, and then calculate control amounts for driver's steering operations based on the analyzed frequency components.

In this way, whenever an external force and/or a driver's steering force are inputted, the steering controller performs a frequency analysis on the inputted force, whereby steering control amounts which are more proper to the inputted force can be calculated precisely.

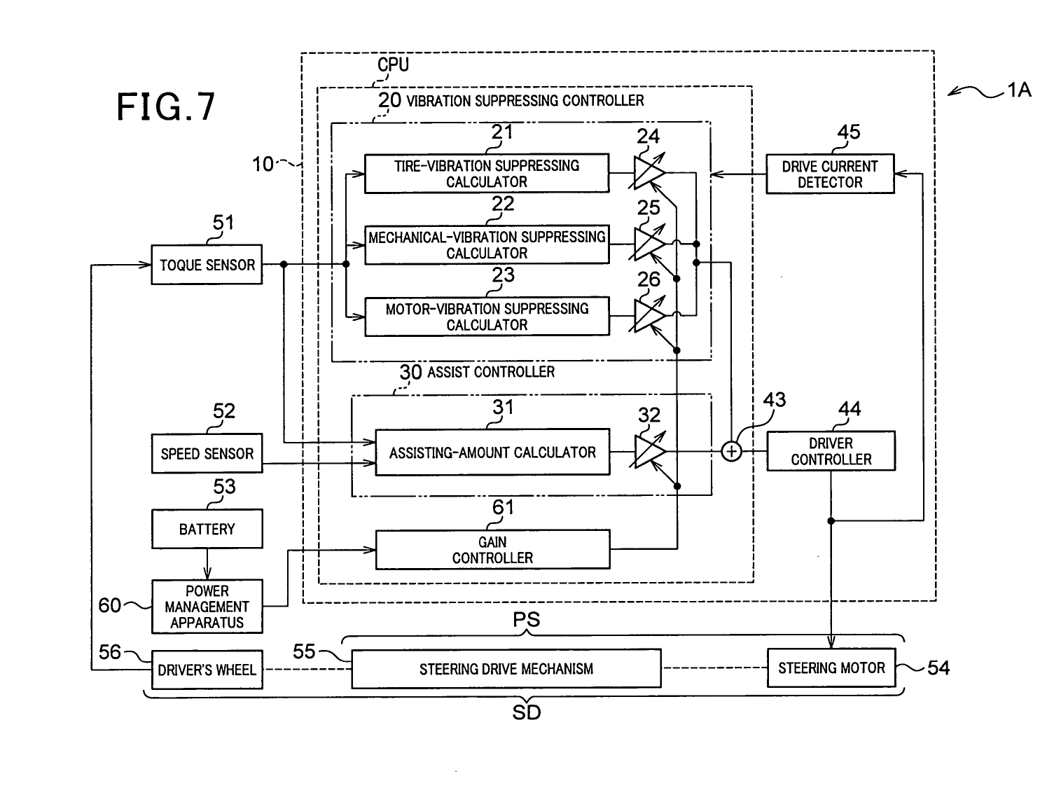

FIG. 7 shows another modification in which another aspect of the present invention is reduced in practice as a steering controller 1A. This steering controller 1A has no noise remover and voltage detector & operation limiter, but instead, has a gain controller 61 that receives from an external power management apparatus 60 information indicative of a margin of the powering capability of the battery 53. The apparatus 60 has a known structure and is able to provide the information on the internal resistance, a state of charge (SOC) indicating a charged rate of the battery, a state of health (SOH) indicating a residual capacity of the battery, and/or other factors showing the powering states of the battery 53.

In this case, the abscissa axis of FIG. 4 should be read as “amount of powering margin” of the battery 53 in place of the battery voltage. The “amount of powering margin” becomes larger as the amount advances rightward along the abscissa axis of FIG. 4. The gain setting lines are set in the same way as foregoing. Therefore, the gain controller 61 reads gains depending on the “amount of powering margin” by referring to the gain setting map shown in the similar way to FIG. 4. Thus, the gain controller 61 in the steering controller 1A is able to determine the margin of the powering capacity of the battery 53, for example, by comparing with a given threshold, and then adjusts the gains at the gain adjustors 24-26 and 32 as described in the foregoing embodiment. It is therefore possible to gain the same or similar advantages as or to the foregoing ones. Especially, the factors for the gain adjustment is not limited to only the battery voltage, so that the width of selection of factors for the adjustment can be widened, providing general versatility to this controller.

In the foregoing embodiment, information showing the current battery voltage can still be used as the margin of the powering capability of the battery 53, instead of using the above various bits of information from the power management apparatus 60.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A controller for controlling a device mounted in a vehicle, the device having an operating member operated by a driver to receive a driver's operating force and an assisting mechanism giving an assisting force to the operating member, the assisting mechanism being powered by a battery mounted in the vehicle, the controller comprising:
a force detector that detects forces applied to the device, the applied forces including the driver's operating force;
a calculator that calculates a control amount giving the assisting force to the device, based on results detected by the force detector, the control amount being calculated every type of the applied forces whose frequency bands are at least partly different from each other;
a driver that drives the assisting mechanism based on the control amount calculated by the calculator;
a battery state detector that detects an operating state of the battery; and
an adjustor that adjusts the control amount such that, as the calculated battery state decreases in a powering function of the battery, the control amount for, of the applied forces, a specified force having specified frequency components is reduced.

2. The controller of claim 1, wherein
the device is a steering apparatus mounted in the vehicle and powered by the battery, the operating member is a driver's wheel of the steering apparatus, the driver's wheel being operated by a driver on the vehicle, the assisting mechanism is a power steering mechanism, and the specified force is a driver's steering force serving as the driver's operating force,
wherein the power steering mechanism includes an electric motor driven by the driver and powered by the battery.

3. The controller of claim 2, wherein
the specified force is a driver's steering force serving as the driver's operating force and the specified frequency components are frequencies of the driver's steering force, of which banes are at least partly lower than other forces of the forces detected by the detector.

4. The controller of claim 3, wherein
the calculator includes first calculating means for calculating a first control amount for the specified force having the specified frequency components based on the results detected by the force detector, the first control amount being part of the control amount, and second calculating means for calculating a second control amount for a force having a frequency higher than the specified frequency components based on the results detected by the force detector, the second control amount being part of the control amount and being for damping the force having the frequency higher than the specified frequency components.

5. The controller of claim 4, wherein the first and second calculating means includes filters in which the detected results are subjected to filtering every band of the frequency components of the forces detected by the force detector.

6. The controller of claim 4, wherein at least one of the first and second calculating means is configured to analyze frequencies of the forces detected by the force detector and calculate at least one of the first and second control amounts based on the analyzed frequencies of the forces.

7. The controller of claim 1, wherein the adjustor is configured to adjust the control amount such that, as the calculated battery state decreases in the powering function of the battery, the amount for each of the applied forces is reduced in a preset order previously set every band of the frequency components of each of the forces detected by the force detector.

8. The controller of claim 7, wherein the preset order is previously set to be an ascending order in which the frequency components of each of the forces become higher.

9. The controller of claim 7, wherein the preset order is previously set to be an order designed on the frequency components of the forces other than the specified force.

10. The controller of claim 7, wherein the adjustor is adapted to adjust the control amount such that the amount for each of the applied forces is monotonously reduced.

11. The controller of claim 1, wherein the adjustor includes means for multiplying the calculated control amount by a coefficient of 0 to 1 decided depending on the detected battery state.

12. The controller of claim 1, wherein the battery state detector is adapted to detect, as the battery state, a terminal voltage of the battery.

13. The controller of claim 12, comprising a noise eliminator, arranged between the battery and the battery state detector, for eliminating an AC component from an output of the battery.

14. A controller for controlling a device mounted in a vehicle, the device having an operating member operated by a driver to receive a driver's operating force and an assisting mechanism giving an assisting force to the operating member, the assisting mechanism being powered by a battery mounted in the vehicle, the controller comprising:
force detecting means for detecting forces applied to the device, the applied forces including the driver's operating force;
calculating means for calculating a control amount giving the assisting force to the device, based on results detected by the force detecting means, the control amount being calculated every type of the applied forces whose frequency bands are at least partly different from each other;
driving means for driving the assisting mechanism based on the control amount calculated by the calculating means;
battery state detecting means for detecting an operating state of the battery; and
adjusting means for adjusting the control amount such that, as the calculated battery state shows a decrease in a powering function of the battery, the control amount for, of the applied forces, a specified force having relatively lower frequency components is monotonously reduced.

15. A controlling apparatus controlling a device mounted in a vehicle, the device allowing a crew's operation, comprising:
detecting means for detecting a force given to the device;
controlling means for controlling, every frequency band, an amount of a force to be controlled by the device in response to at least one of the crew's operation and a detected result by the controlling means;
estimating means for estimating a margin of power available for the controller; and
selecting means for selecting the frequency band that is subjected to a reduction in the amount of the force to be controlled in the controlling means, based on an estimated result by the estimating means.

16. The controller of claim 15, wherein
the device is a steering apparatus mounted in the vehicle and powered by a battery mounted in the vehicle.

17. The controlling apparatus of claim 16, wherein the selecting means selects the frequency band in an order along which the frequency band becomes higher as the margin decreases.
